(19) United States
(12) Patent Application Publication
(10) Pub. No.: US 2012/0307022 A1
(43) Pub. Date: Dec. 6, 2012

(54) INFORMATION PROCESSOR AND CALIBRATION METHOD

(76) Inventor: Masaaki Ikuta, Tokyo (JP)

(21) Appl. No.: 13/434,206

(22) Filed: Mar. 29, 2012

(30) Foreign Application Priority Data
May 31, 2011 (JP) 2011-122728

(51) Int. Cl. H04N 13/04; G06F 3/033

(52) U.S. Cl. 348/51; 345/158; 348/E13.026

(57) ABSTRACT

According to one embodiment, an information processor includes: a display module; a detector; a first operation receiver; a second operation receiver; a display controller; and an adjuster. The display module displays a video. The detector detects a position of a hand of an operator. The first operation receiver receives an operation from the operator with a first operation reception mode. The second operation receiver receives an operation from the operator based on a detection result of the detector with a second operation reception mode. The display controller controls the display module to display a confirmation screen to confirm that, if the first operation reception mode is to be changed to the second operation reception mode, the change of the mode. The adjuster adjusts a parameter relating to detection of position of the hand based on the detection result of the detector while the confirmation screen is displayed.

### CROSS-REFERENCE TO RELATED APPLICATIONS

This application is based upon and claims the benefit of priority from Japanese Patent Application No. 2011-122728, filed on May 31, 2011, the entire contents of which are incorporated herein by reference.

### FIELD

An embodiment described herein relates generally to an information processor and a calibration method.

### BACKGROUND

In information processors such as personal computers (PCs), user interface systems have been proposed that detect positions and movements of hands (gestures) of operators and can operate the information processors based on the gestures. In an example of such user interface systems, an operator can operate the information processor both by touching and without touching the information processor.

In a user interface system requiring an operator to touch the information processor, some techniques cause errors in position detection accuracy due to individual differences of operators. When an operator operates the information processor employing such a technique, calibration needs to be performed prior to the use of the information processor. Performing operation only for calibration is cumbersome for the operator and hampers user-friendliness of the information processor.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary perspective view of an outer appearance of a television according to an embodiment;

FIG. 2 is an exemplary schematic diagram of a signal processing system of the television in the embodiment;

FIGS. 3A and 3B are exemplary schematic diagrams for explaining variations of reflection light intensity in the embodiment;

FIG. 4 is an exemplary flowchart of operation reception processing in the embodiment;

FIG. 5 is an exemplary schematic diagram of a confirmation screen in the embodiment; and

FIG. 6 is an exemplary schematic diagram of a positional operation screen in the embodiment.

### DETAILED DESCRIPTION

In general, according to one embodiment, an information processor comprises: a display module; a detector; a first operation receiver; a second operation receiver; a display controller; and an adjuster. The display module is configured to display a video. The detector is configured to detect a position of a hand of an operator. The first operation receiver is configured to receive an operation from the operator with a first operation reception mode. The second operation receiver is configured to receive an operation from the operator based on a detection result of the detector with a second operation reception mode. The display controller is configured to control the display module to display a confirmation screen to confirm that, if the first operation reception mode is to be changed to the second operation reception mode, the change of the mode. The adjuster is configured to adjust a parameter relating to detection of position of the hand based on the detection result of the detector while the confirmation screen is displayed.

An embodiment of an information processor and a calibration method is described in detail below with reference to the accompanying drawings. In the following embodiment, an example is described in which the information processor is applied to a television. The information processor, however, is not limited to the television, and may be applied to a personal computer (PC), a tablet PC, a photo frame, and a portable electronic apparatus, for example.

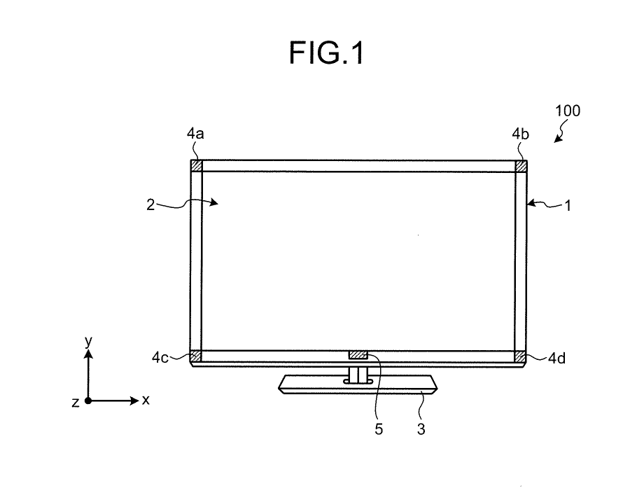

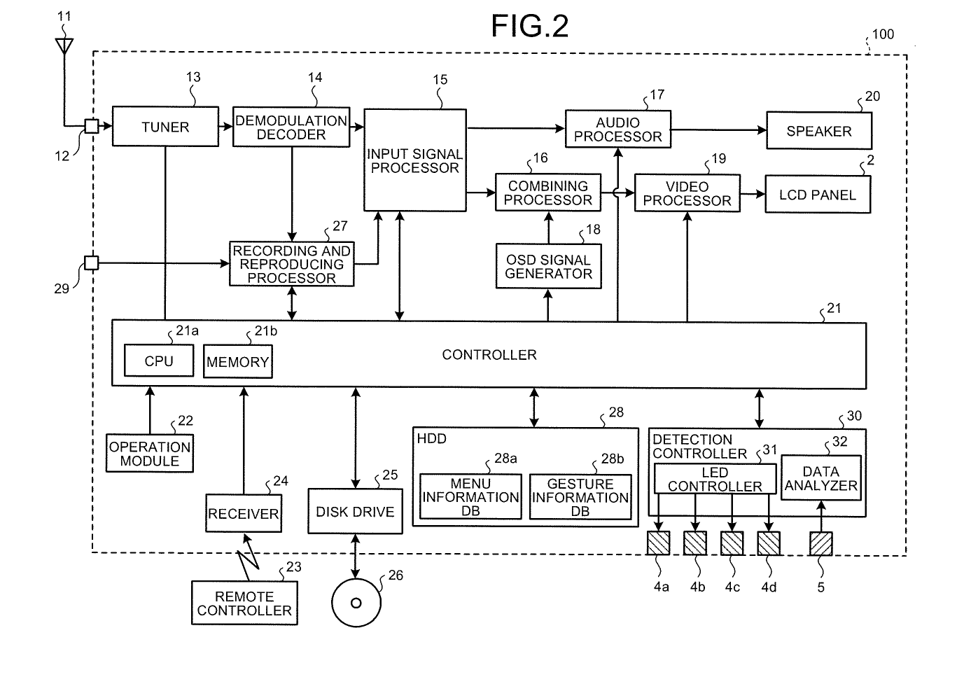

FIG. 1 is a front view illustrating a television 100 as an example of the information processor according to the embodiment. As illustrated in FIG. 1, the television 100 has a rectangular shape when viewed from the front (a plan view of the front surface). The television 100 comprises a housing 1 and a liquid crystal display (LCD) panel 2. The LCD panel 2 receives a video signal from a video processor 19 (see FIG. 2), which is described later, and displays images such as still images and moving images. The housing 1 is supported by a supporter 3.

The housing 1 is provided with four infrared light emitting diodes (LEDs) 4a, 4b, 4c, and 4d at four corners thereof. The housing 1 is provided with a photodetector 5 at a lower center thereof. Infrared light emitted from the four infrared LEDs is reflected by an object (such as a viewer) present in front of the television 100, and the reflected light is received by the photodetector 5. The television 100 detects a movement of a hand of a viewer as a gesture based on a light receiving result of the photodetector 5, and receives operation input with the gesture. The positions at which the infrared LEDs and the photodetector 5 are disposed are not limited to those in the example illustrated in FIG. 1. The number of infrared LEDs is not limited to a specific number as long as it is two or more. A plurality of photodetectors 5 may be provided (e.g., the photodetector 5 is provided for each infrared LED).

FIG. 2 is a block diagram illustrating a signal processing system of the television 100. As illustrated in FIG. 2, the television 100 can select a broadcast signal of a desired channel by supplying a digital television broadcast signal received by an antenna 11 to a tuner 13 that is a receiver through an input terminal 12. The television 100 supplies the broadcast signal selected by the tuner 13 to a demodulation decoder 14, in which the broadcast signal is restored to a digital video signal and a digital audio signal, and outputs the restored signals to an input signal processor 15.

The input signal processor 15 performs predetermined digital signal processing on the digital video and the audio signals supplied from the demodulation decoder 14.

The input signal processor 15 outputs the digital video signal to a combining processor 16 and the digital audio signal to an audio processor 17. The combining processor 16 superimposes an on screen display (OSD) signal on the digital video signal supplied from the input signal processor 15, and outputs the resulting signal. The OSD signal is a video signal produced by an OSD signal generator 18, such as caption, graphical user interface (GUI), and the OSD, and superimposed. In the embodiment, the combining processor 16 superimposes the OSD signal supplied from the OSD signal generator 18 on the video signal supplied from the input signal processor 15 without any change, and outputs the resulting signal.

The television 100 supplies the digital video signal output from the combining processor 16 to the video processor 19. The video processor 19 converts the received digital video signal into an analog video signal having a format capable of being displayed by the LCD panel 2 functioning as an output module. The television 100 supplies the analog video signal output from the video processor 19 to the LCD panel 2 so as to be output as video output.

The audio processor 17 converts the received digital audio signal into an analog audio signal having a format capable of being reproduced by a speaker 20 provided in a subsequent stage. The analog audio signal output from the audio processor 17 is supplied to the speaker 20 so as to be reproduced as audio output.

The television 100 overall controls, by a controller 21, all of the performances thereof including the above-described various receiving performances. The controller 21 comprises a central processing unit (CPU) 21a. The controller 21 receives operation information from an operation module 22 provided on a main body of the television 100 as an operation device, or operation information that is sent from a remote controller 23 serving as the operation device and received by a receiver 24, and controls each module in the television 100 such that a operation content is achieved. The controller 21 detects a movement of a hand of a viewer as a gesture in cooperation with a detection controller 30, which is described later, and controls each module such that the operation content represented by the gesture is realized.

The controller 21 comprises a memory 21b. The memory 21b comprises, as main modules, a read only memory (ROM) storing a control program executed by the CPU 21a, a random access memory (RAM) providing a working area to the CPU 21a, and a non-volatile memory storing information such as various setting and control information and operation information from the operation module 22 and the remote controller 23.

The controller 21 is coupled to a disk drive 25. An optical disk 26, such as a digital versatile disk (DVD), is attachable to and detachable from the disk drive 25. The disk drive 25 has a function to record digital data to and reproduce digital data of the optical disk 26 inserted thereto.

The controller 21, based on viewer's operation with the operation module 22 or the remote controller 23, can control a recording and reproducing processor 27 to encrypt the digital video and the audio signals received from the demodulation decoder 14, convert them into a predetermined recording format, and supply them to the disk drive 25 so as to be recorded into the optical disk 26.

The controller 21, based on viewer's operation with the operation module 22 or the remote controller 23, can control the disk drive 25 to read the digital video and the audio signals from the optical disk 26, and control the recording and reproducing processor 27 to decode them and supply decoded signals to the input signal processor 15 so that the supplied signals are thereafter subjected to video display and audio reproduction.

The controller 21 is coupled to a hard disk drive (HDD) 28. The controller 21, based on viewer's operation with the operation module 22 or the remote controller 23, can control the recording and reproducing processor 27 to encrypt the digital video and the audio signals received from the demodulation decoder 14, convert them into a predetermined recording format, and supply them to the HDD 28 so as to be recorded therein.

The controller 21, based on viewer's operation with the operation module 22 or the remote controller 23, can read the digital video and the audio signals from the HDD 28, and control the recording and reproducing processor 27 to decode them and supply decoded signals to the input signal processor 15 so that the supplied signals are thereafter subjected to video display and audio reproduction.

The HDD 28 stores therein various data and functions as a menu information database (menu information DB) 28a and a gesture information database (gesture information DB) 28b. The menu information database 28a stores therein menu configuration information to configure the GUI and the OSD. The gesture information database 28b stores therein predetermined patterns (gesture patterns) of gestures and commands corresponding to operation contents represented by the gesture patterns such that the gesture patterns correspond to the respective commands.

The gesture patterns are classified into two types. With a first gesture pattern, an operation content is defined by a gesture alone, i.e., a trajectory of the movement of the gesture. For example, waving of a hand, as the first gesture pattern, defines an operation content (command), and in accordance with the gesture, volume is increased or decreased, or channels are switched. Hereinafter, operation with the first gesture pattern is referred to as a “gesture operation mode”.

With a second gesture pattern, an operation content is defined by a set of a gesture itself and a position (operation position) at which the gesture is performed. The second gesture pattern is based on operation performed on the GUI displayed on the LCD panel 2. For example, performing a gesture representing a selection such as a tap operation on a selector such as a button displayed on the LCD panel 2 defines an operation content (command), and in accordance with the gesture, the button is depressed. Hereinafter, operation with the second gesture pattern is referred to as a “positional operation mode”.

The television 100 is provided with an input terminal 29. External digital video and audio signals are directly input to the input terminal 29 of the television 100. The digital video and audio signals received through the input terminal 29 are supplied to the input signal processor 15 after passing through the recording and reproducing processor 27 and thereafter subjected to video display and audio reproduction as described above, under the control of the controller 21.

The digital video and audio signals received through the input terminal 29 are supplied to the disk drive 25 so as to be recorded into or reproduced from (after recorded) the optical disk 26, or to the HDD 28 so as to be recorded thereinto or reproduced therefrom (after recorded) after passing through the recording and reproducing processor 27, under the control of the controller 21.

The controller 21, based on viewer's operation with the operation module 22 or the remote controller 23, controls the disk drive 25 and the HDD 28 so that the digital video and the audio signals recorded in the optical disk 26 are recorded into the HDD 28, or the digital video and the audio signals recorded in the HDD 28 are recorded into the optical disk 26.

The controller 21 is coupled to the detection controller 30. The detection controller 30 comprises an LED controller 31 and a data analyzer 32. The LED controller 31 controls light emitting timing of the infrared LEDs 4a, 4b, 4c, and 4d. Specifically, the LED controller 31 allows each of the infrared LEDs 4a, 4b, 4c, and 4d to emit light in a time division manner in a predetermined order (e.g., 4a→4b→4c→4d) under the control of the controller 21. In this regard, it is necessary to identify that which light is emitted from which infrared LED. The following exemplary methods are used: a method in which the infrared LEDs emit pulse light components having different pulse phases, and a method in which the infrared LEDs emit sine wave light components having different frequencies or phases.

The data analyzer 32 analyzes each of reflection light components relating to the infrared LEDs received by the photodetector 5 and acquires each of reflection light intensities representing levels of received light amounts of reflection light components. The data analyzer 32 outputs each acquired reflection light intensity to the controller 21 together with identification information identifying the corresponding infrared LED.

When receiving the identification information and the reflection light intensity relating to each infrared LED from the data analyzer 32, the controller 21 detects a position of a hand of a viewer based on the reflection light intensity of each infrared LED, and detects the movement of the position of the hand of the viewer as a gesture based on a temporal change of the position. The controller 21 checks the detected gesture with each gesture pattern stored in the gesture information database 28b of the HDD 28, executes a command corresponding to the gesture pattern coinciding with the detected gesture, and controls each module such that the operation content instructed by the gesture is achieved.

The method of detecting the operation position is not limited to a specific method. Any known technique can be used as the detection method. In the embodiment, the operation position of an operator is identified (detected) by using the following formulas (1) to (3). The operation position is represented by three-dimensional information (x, y, z) by using a display surface (e.g., a central part of a screen) of the LCD panel 2 as a reference.

x=(a*(b*LED2−c*LED1)+d*(e*LED4−f*LED3))*g (1)

y=(h*(i*LED3−j*LED1)+k*(1*LED4−m*LED2))*n (2)

z=o*(p*LED1+q*LED2+r*LED3+s*LED4) (3)

In formulas (1) to (3), LED 1 is the reflection light intensity relating to the infrared LED 4a, LED 2 is the reflection light intensity relating to the infrared LED 4b, LED 3 is the reflection light intensity relating to the infrared LED 4c, and LED 4 is the reflection light intensity relating to the infrared LED 4d, and a to s are coefficients.

The controller 21, at calibration, corrects the operation position (x, y, z) of each viewer to a reference position used as a reference of detecting a gesture by adjusting values of the coefficients a to s. The calibration is performed as follows: a viewer taps a predetermined position (e.g., the central part of the screen) of the LCD panel 2 as a gesture, and the calibration is performed based on a tap position (operation position) obtained at the tap operation.

Specifically, the values of the coefficients o to s of formula (3) are adjusted such that a distance between the display surface of the LCD panel 2 and the operation position (in a z direction illustrated in FIG. 1) is a predetermined vertical reference value. In addition, the values of the coefficients a to n of formulas (1) and (2) are adjusted such that the operation position on a plane parallel to the display surface of the LCD panel 2 (an x-y plane illustrated in FIG. 1) is a predetermined horizontal reference position. For example, the vertical reference value is “zero”, meaning that the operation position is on the display surface while the horizontal reference position is the central position of the display surface. The horizontal reference position and the vertical reference position are preliminarily stored, for example, in the HDD 28 as setting information.

It is preferable that the calibration be performed for each viewer operating the television 100 because the acquired value of reflection light intensity varies depending on each viewer due to individual difference. For example, different sizes of hands or different posture of a hand with respect to the display surface of the LCD panel 2 cause different obtained results (reflection light intensity) even when gestures are performed at the same operation position.

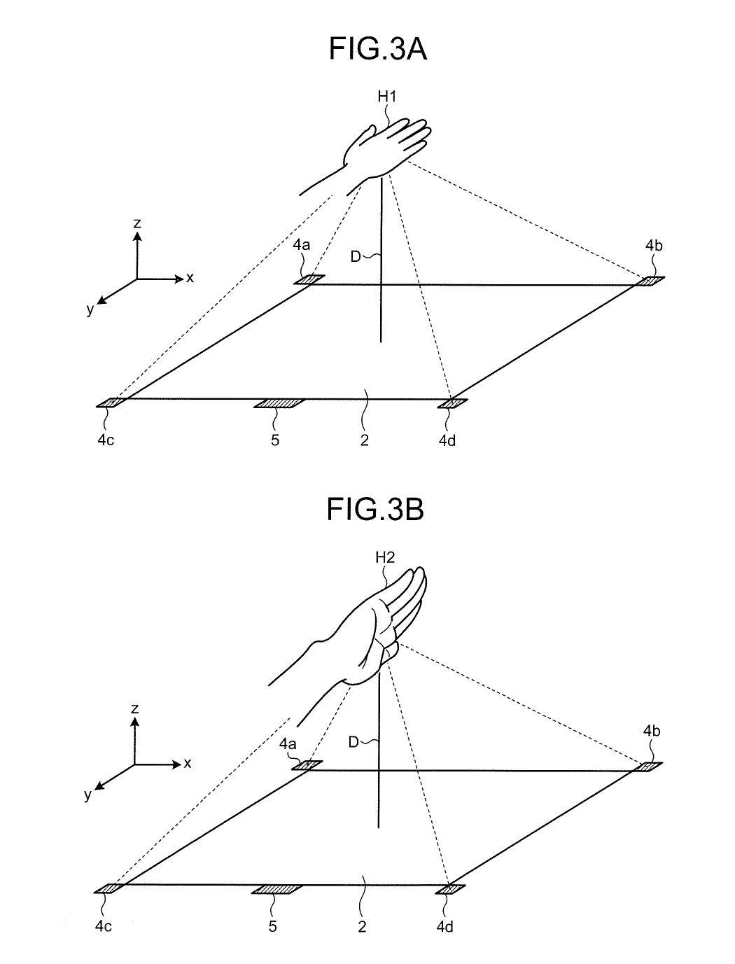

FIGS. 3A and 3B are schematics to explain the variation of reflection light intensity due to individual difference. FIG. 3A illustrates a state in which a hand H1 is held over the display surface so as to be parallel to the display surface (in the x-y direction) . FIG. 3B illustrates a state in which a hand H2 bigger than the hand H1 is rotated in counterclockwise direction from the posture of the hand H1 positioned above the central part of the display surface of the LCD panel 2 as a reference such that the palm of the hand H2 faces in an x-axis direction. In FIGS. 3A and 3B, a distance D between the LCD panel 2 and the hand is equal to each other.

As illustrated in FIGS. 3A and 3B, the distances between the hand and the infrared LEDs 4a, 4b, 4c, and 4d differ in FIGS. 3A and 3B (refer to dot line lengths) between which sizes and posture of hands differ. Therefore, the acquired values of the reflection light intensities of the infrared LEDs detected by the photodetector 5 differ between FIGS. 3A and 3B. For example, in FIG. 3A, the reflection light intensities of the infrared LEDs are nearly equal to each other while, in FIG. 3B, the reflection light intensities of the infrared LEDs 4b and 4c are nearly equal to each other but the reflection light intensities of the infrared LEDs 4d and 4a are different.

Because of the variation of reflection light intensity due to individual difference as described above, if a viewer having the hand H2 performs a gesture under the calibration of a viewer having the hand H1, it is determined that the operation positions are different from each other even though both operation positions are the same in an operation space. In the gesture operation mode, the error of the operation position does not particularly cause problems because detecting a gesture alone is all that is needed. On the other hand, in the positional operation mode, an error of a measurement position causes the occurrence of incorrect operation because the operation position needs to be identified.

Accordingly, a viewer who intends to operate the television 100 with the positional operation mode needs to complete calibration in advance. Performing the operation for calibration every time is cumbersome for the viewer and hampers user-friendliness of the television 100.

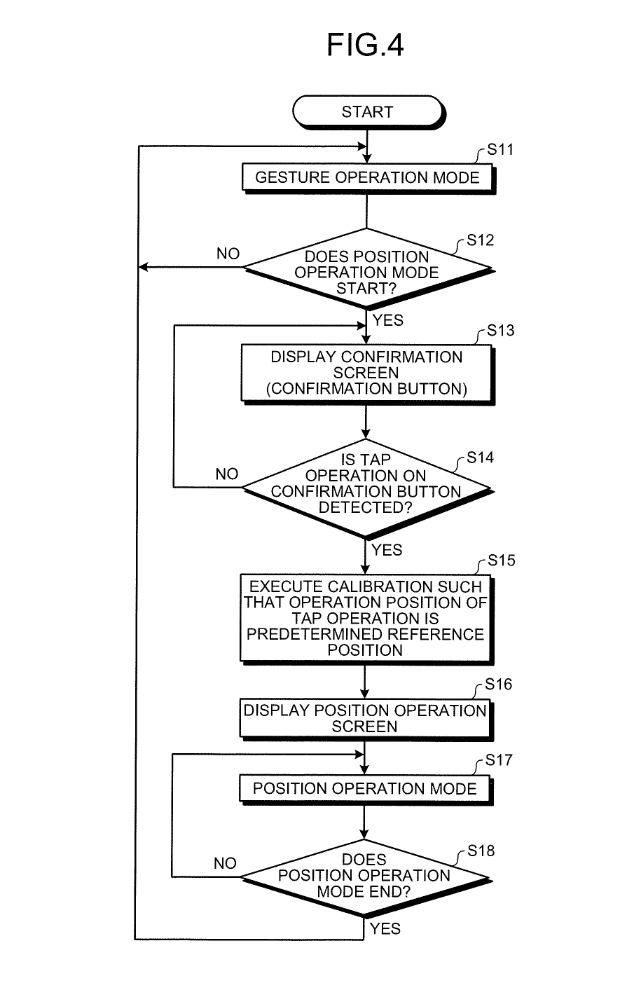

In the television 100 of the embodiment, calibration is not executed in such a manner as described above. If the mode is changed from the gesture operation mode to the positional operation mode, a confirmation screen to confirm the change to the positional operation mode is displayed, and calibration is executed based on the operation position of a gesture obtained at a response on the confirmation screen. The calibration executed in the television 100 is described with reference to FIGS. 4 to 6.

FIG. 4 is a flowchart of operation reception processing executed by the controller 21 of the television 100. The controller 21 first operates with the gesture operation mode (S11). At S11, the controller 21 detects a gesture of a viewer based on the reflection light intensities of the infrared LEDs 4a to 4d received from the detection controller 30, and if the detected gesture coincides with a gesture pattern of the gesture information database (the first gesture pattern), executes the command corresponding to the first gesture pattern.

If a start of the positional operation mode is instructed by the operation module 22, the remote controller 23, or a gesture (the first gesture pattern) (Yes at S12), the controller 21 controls the OSD signal generator 18 to produce the confirmation screen to confirm the start of the positional operation mode so as to display the confirmation screen on the LCD panel 2 (S13). If the start of the positional operation mode is not instructed (No at S12), the controller 21 continues to operate with the gesture operation mode.

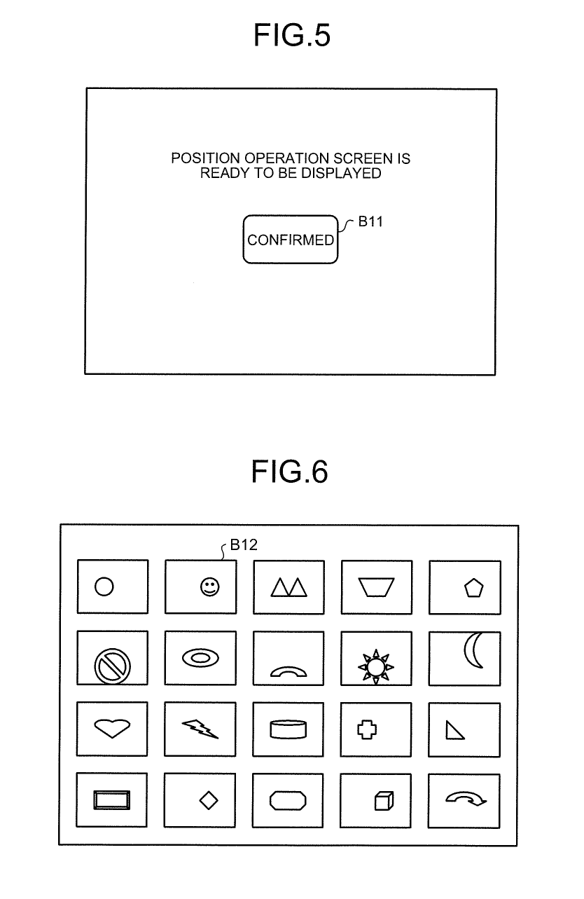

FIG. 5 is a schematic diagram illustrating an example of the confirmation screen displayed on the LCD panel 2. As illustrated in FIG. 5, a confirmation button B11 to confirm the change to the positional operation mode is disposed at the center of the confirmation screen, i.e., the above-described tap position in calibration. The configuration of the confirmation screen is not limited to that of the example of FIG. 5.

The controller 21 waits until the confirmation button B11 illustrated in FIG. 5 is tapped (No at S14). If an area excluding the area in which the confirmation button B11 is disposed is tapped, the controller 21 disables the tap operation.

If the controller 21 detects the tap operation of the confirmation button B11 (the second gesture pattern) in cooperation with the detection controller 30 (Yes at S14), the controller 21 executes calibration to adjust the coefficients a to s of formulas (1) to (3) such that the operation position at which the tap operation is performed is set as a predetermined reference position (S15).

Then, the controller 21 controls the OSD signal generator 18 to produce the GUI used for the positional operation mode (hereinafter, referred to as a positional operation screen) based on menu configuration information stored in the menu information database 28a so as to display the positional operation screen on the LCD panel 2 (S16).

FIG. 6 is a schematic diagram illustrating an example of the positional operation screen displayed on the LCD panel 2. As illustrated in FIG. 6, selectors B12 to instruct various operations to the television 100 are disposed on the positional operation screen. The selectors B12 may be operation buttons or icon images, for example. Commands instructing channel numbers in the tuner 13 and realizing various functions of the television 100 are allocated to the selectors B12. The configuration of the positional operation screen is not limited to that of the example of FIG. 6.

Then, the controller 21 waits for the operation on the positional operation screen, and when the tap operation on any of the selectors B12 (the second gesture pattern) is detected in cooperation with the detection controller 30, executes the command corresponding to the tapped selector B12 (S17). The detection of the tap operation at S17 can detect the operation position at which the tap operation is performed with a high accuracy because the calibration is performed at S15 prior to S17. The operation with the gesture operation mode is received even in the operation with the positional operation mode.

The controller 21 continues the processing at S17 until an end of the positional operation mode is instructed (No at S18). If the end of the positional operation mode is instructed by the operation module 22, the remote controller 23, or a gesture (the first gesture pattern) (Yes at S18), the controller 21 returns to S11.

As described above, according to the embodiment, when a change to the positional operation mode is instructed by the operation module 22, the remote controller 23, or a gesture (the first gesture pattern), the confirmation screen to confirm the change to the positional operation mode is displayed, and then calibration is executed based on the operation position obtained at a response on the confirmation screen. In this way, calibration is executed in a normal operation flow and a viewer is not aware of the calibration. As a result, the viewer can save performing operation only for calibration and user-friendliness of the television 100 can be enhanced.

While the confirmation screen (refer to FIG. 5) and the positional operation screen (refer to FIG. 6) are displayed on the display surface of the LCD panel 2 in the embodiment, they are not necessarily displayed in this manner. For example, when the television 100 can provide stereoscopic vision, the confirmation screen and the positional operation screen may be displayed in stereoscopic vision (three-dimensional images). In this case, the reference position (the vertical reference value and the horizontal reference position) of gesture detection is determined depending on a protruded amount from the display surface of the positional operation screen. Specifically, a protruded amount of stereoscopic vision is preferably nearly equal to the vertical reference value, while the central position of a screen in stereoscopic vision is preferably set as the horizontal reference position.

The method to realize stereoscopic vision is not limited to a specific method. Any known technique such as an active shutter method using glasses, and a naked-eye stereoscopic vision method (e.g., an integral imaging method, a lenticular method, and a parallax barrier method) can be used. For example, when the active shutter method is employed, an image for a right eye and an image for a left eye (e.g., the confirmation screen and the positional operation screen) are displayed on the LCD panel 2 by being switched at high speed, and, in synchronization with the switching, right and left views of liquid crystal shutter glasses are alternately interrupted. As a result, a viewer can see stereoscopic vision. When the naked-eye stereoscopic vision method is employed, a lenticular lens array or a liquid crystal gradient index (GRIN) lens is provided in front of the LCD panel 2, and a multi-view image having a predetermined disparity amount (e.g., the confirmation screen and the positional operation screen) for stereoscopic vision is displayed on the LCD panel 2. As a result, a viewer can see stereoscopic vision.

While the detection controller 30 is provided as the individual module in the embodiment, the detection controller 30 is not necessarily provided in this manner. The function of the detection controller 30 may be included in the controller 21. In the embodiment, the infrared LEDs are used for detecting gestures. The detection method, however, is not limited to use the infrared LEDs. Any light emitting element may be used for detecting gestures.

While the program executed by the television 100 is preliminarily built in the HDD 28 or the memory 21b and provided in the embodiment, the program is not necessarily provided in this manner. The program may be recorded and provided in a recording medium readable by a computer, such as a compact disk ROM (CD-ROM), a flexible disk (FD), a CD-recordable (CD-R), and a digital versatile disk (DVD), with a format installable or in a file executed by the computer. Furthermore, the storage medium is not limited to a medium separated from the computer or a built-in system, and examples of the storage medium comprise a storage medium in which a program transmitted through, for example, a local area network (LAN) or the Internet is downloaded and stored or temporarily stored.

The program executed by the television 100 of the embodiment may be stored in a computer coupled with a network such as the Internet, and may be provided by being downloaded through the network, or provided or distributed through a network such as the Internet.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processor comprising:
a display module configured to display a video;
a detector configured to detect a position of a hand of an operator;
a first operation receiver configured to receive an operation from the operator with a first operation reception mode;
a second operation receiver configured to receive an operation from the operator based on a detection result of the detector with a second operation reception mode;
a display controller configured to control the display module to display a confirmation screen to confirm that, if the first operation reception mode is to be changed to the second operation reception mode, the change of the mode; and
an adjuster configured to adjust a parameter relating to detection of position of the hand based on the detection result of the detector while the confirmation screen is displayed.

2. The information processor of claim 1, wherein
the display controller is configured to control the display module to display the confirmation screen in which a selector for confirming the change to the second operation reception mode is disposed at a certain position serving as a reference of the adjustment, and,
if the second operation receiver receives an operation indicating the position at which the selector is disposed, the adjuster adjusts the parameter relating to the detection of the position of the hand based on the detection result of the detector relating to the operation.

3. The information processor of claim 2, wherein the second operation receiver is configured to disable selection input with respect to an area excluding the position at which the selector is disposed.

4. The information processor of claim 1, wherein
the display module is configured to display the operation screen and the confirmation screen in stereoscopic vision, and
the adjuster is configured to adjust the parameter relating to the detection of the position based on a protruded amount from a display surface of the confirmation screen.

5. The information processor of claim 1, further comprising a gesture detector configured to detect, as a gesture, the movement of the hand of the operator detected by the detector, wherein
the first operation receiver is configured to receive the gesture detected by the gesture detector as operation with the first operation reception mode.

6. The information processor of claim 1, wherein the detector is configured to detect the position of the hand of the operator based on a reflection light of light beams output from a plurality of light sources.

7. The information processor of claim 6, wherein the light sources are arranged on circumference of a display surface of the display module.

8. A calibration method executed by an information processor comprising a display module configured to display an image and a detector configured to detect a position of a hand of an operator, the method comprising:
receiving, by a first operation receiver, an operation from the operator with a first operation reception mode;
receiving, by a second operation receiver, an operation from the operator based on a detection result of the detector with a second operation reception mode;
controlling, by a display controller, the display module to display a confirmation screen to confirm that, if the first operation reception mode is to be changed to the second operation reception mode, the change of the mode; and
adjusting, by an adjuster, a parameter relating to detection of position of the hand based on the detection result of the detector while the confirmation screen is displayed.
